(19) United States
(12) Patent Application Publication
(10) Pub. No.: US 2010/0230027 A1
(43) Pub. Date: Sep. 16, 2010

(54) DEVICE FOR REDUCING THE POWER OF WATER EXPULSION FOR A TIRE

(76) Inventors: Jean-Marc D'Harcourt, Clermont-Ferrand (FR); Catherine Houis, Clermont-Ferrand (FR)

Correspondence Address: BUCHANAN, INGERSOLL & ROONEY PC, POST OFFICE BOX 1404, ALEXANDRIA, VA, 22313-1404, US

(21) Appl. No.: 12/602,563

(22) PCT Filed: Jun. 2, 2008
(86) PCT No.: PCT/EP2008/056745

§ 371 Date: Mar. 30, 2010

(30) Foreign Application Priority Data
Jun. 1, 2007 (FR) 0703929

(51) Int. Cl. B60C 13/02

(52) U.S. Cl. 152/523

(57) ABSTRACT

Tire having a tread, sidewalls extending the edges of the tread and, on at least one of its sidewalls, a rib for modifying the path of the expelled water in the case of the tire running on wet ground, this rib furthermore including a power-reducing device positioned on the external wall of the rib so as to reduce the power of the water expelled in the transverse direction while the tire is running on ground covered with water, said power-reducing device comprising at least one protuberance placed in the circumferential direction and extending in the radial direction.

### FIELD OF INVENTION

The invention relates to tires for heavy-goods road vehicles and in particular tires that are provided with devices for deflecting laterally expelled water when a vehicle equipped with said tires runs on a roadway covered with water.

### BACKGROUND OF INVENTION

When driving in rainy weather, the manoeuvres of passing or overtaking a heavy-goods vehicle are often very fraught for the other road users because of the large amount of water that may be laterally expelled by said vehicle, which water, on reaching the windscreens of the other vehicles, considerably reduces the visibility of the drivers of these vehicles.

A heavy-goods vehicle tire is in general made up of two beads intended to be in contact with a wheel rim, a crown provided with a tread having a running surface, intended to come into contact with the ground when the vehicle is running, and two sidewalls for joining this tread to the beads.

Such a tire is reinforced by a carcass reinforcement extending from one bead to the other and by a crown reinforcement located radially to the outside of the carcass reinforcement, this crown reinforcement comprising at least two superposed reinforcing plies, i.e. plies placed one on top of another. Each ply of the crown reinforcement is in general made up of a plurality of reinforcing members placed so as to make an angle ranging from 0° to 70° with the circumferential direction. However, it is not excluded for the angle of the reinforcing members to be greater than 70°.

The tread of a heavy-goods vehicle tire is as a general rule provided with a tread pattern formed from raised elements bounded by cuts (grooves and/or incisions) designed to give the tire grip on a wet road, in particular allowing water to be expelled.

The tire has a maximum width dimension L measured at its sidewalls when it is fitted onto its fitting wheel and subjected to the nominal pressure and load conditions when it is in use (L represents the maximum distance between the points on the sidewalls of the tire that are axially furthest apart). The term “axially” or the term “transversely” denotes in the present description a direction parallel to the axis of the rotation of the rim-fitted tire.

European Patent EP 1 048 489 discloses the use of a device that substantially modifies the path of the laterally expelled water when the vehicle is running on a roadway covered with water. This device comprises, on at least one of the sidewalls of the tire, at least one circumferential rib made of a rubber compound.

The purpose of this protuberance is to lower the path of the stream of liquid expelled by the running tire towards the roadway so as to prevent this stream from being expelled excessively upwards, forming splashes that hamper the other road users.

Furthermore, the solution described in that patent makes it possible to limit the temperature rises within the tread and especially near the ends of the crown reinforcement plies.

However, it appears that, when in use, the device described in that patent can be further improved. This is because it has been found that the deflected stream could be perceived as being too powerful and could then reach quite large distances in a transverse direction with respect to the path followed by the tire.

The tire of the invention seeks to improve this state of affairs by proposing a solution which, while still deflecting the stream of liquid when the tire is running on a water-covered roadway, reduces the power of this stream and reduces the maximum distance of expulsion of the liquid in the transverse direction.

### SUMMARY OF THE INVENTION

For this purpose, a heavy-goods vehicle tire according to the invention comprises a tread intended to come into contact with a running surface of a roadway when the tire is running thereon, sidewalls extending on either side of the tread and, on at least one of its sidewalls, a rib for modifying the path of the expelled water in the case of the tire running on wet ground, this rib being oriented in the circumferential direction.

This rib comprises an external wall formed from a first part and from a second part, the first part extending between a sidewall of the tire as far as a line joining the axially outermost points of the rib, the second part being in the extension of the first part and extending radially outwards as far as an axially external edge of the tread.

This tire is characterized in that the rib for modifying the path of the stream is provided with a power-reducing device, said power-reducing device being positioned on the second part of the external wall of the rib and comprising at least one protuberance projecting from this second part of the external wall and placed so as to create a pressure drop so as to reduce the power of the water expelled in the transverse direction (i.e. in a direction parallel to the rotation axis of the tire) in the case of the tire running on water-covered ground. In addition, said at least one protuberance intersects a virtual line (T) tangential to both the axially outer edge (N1) of the tread and the rib on which said at least one protuberance is formed.

In an advantageous embodiment, the at least one protuberance of the power-reducing device is formed by a plurality of studs of appropriate cross section and of appropriate length so as to create a pressure drop in the expelled water. Each stud is an elongate element made of a rubber material that may be of the same nature as the material constituting the circumferential rib provided on the sidewall. The term “elongate element” should be understood to mean that the maximum dimensions of its cross section are at least 1.5 times smaller than the height of the element.

Advantageously, the studs are oriented in a radial (or substantially radial) direction—i.e. in a direction perpendicular to the rotation axis—and they have a length sufficient to effect a reduction in power of the expelled fluid. When the tire is running, they may or may not touch the roadway when said tire is new and when it supports its nominal load and is inflated to its nominal pressure.

In an advantageous embodiment for increasing the pressure drop without however stopping the expulsion of the water, the studs are placed in at least two circumferential lines on the second part of the external wall of the rib, the studs of one line being offset circumferentially relative to the studs of a neighboring line so as to create a large number of obstacles to the flow of water when the tire is running on water-covered ground.

Varied shapes of cross sections may be used for the studs, especially circular, quadrangular or triangular shapes.

Each stud may have a constant cross section or else one that can vary in its height direction. For example, it is possible to design studs having cross sections, the area of which increases upon moving towards the wall of the circumferential rib. It is also possible to provide studs, the cross-sectional area of which decreases upon coming closer to the wall of the circumferential rib so as to have a substantially constant flexural rigidity after the studs have been partially worn away during running.

Advantageously, the void content of the protuberances of the power-reducing device, measured when projected on a plane perpendicular to the rotation axis, is at most equal to 15% of the total area of the studs projected on the same plane. This void content represents in fact the space not occupied by one or more studs through which a stream can pass without being deflected. A void content of 0% means that there is no free passage between the studs in a direction parallel to the rotation axis. The higher this void content, the less the stream is disturbed by the studs. It has been found that above 15% the void content is too high to obtain an appreciable effect of reducing the power of the stream.

In another embodiment, a tire according to the invention is characterized in that the at least one protuberance of the power-reducing device is formed by at least one strip, the dimensions of the cross section of which, (seen in a meridian section plane, i.e. in any plane containing the rotation axis) are such that, under the action of the expelled water, said strip deforms in bending, the at least one strip having a circumferential main orientation so as to reduce the power of the water expelled in the transverse direction in the case of the tire running on water-covered ground. The expression “circumferential main orientation” is understood here to mean that this strip may be of zigzag form, while making one complete revolution of the tire (about the rotation axis of said tire).

In another embodiment, the tire is characterized in that at least one strip is continuous in the circumferential direction (in the present case, this strip may be a rectilinear strip or else a zigzag strip). Preferably, the strip is discontinuous, i.e. formed by a succession of small tabs placed in the circumferential direction so as to be less sensitive to external abuse (especially impact against a pavement).

In another advantageous embodiment, the device for reducing the power of the expelled water is formed by a plurality of discontinuous circumferential tabs placed in circumferential rows, the tabs of one line being circumferentially offset relative to the tabs of another row.

When the tire includes a crown reinforcement located radially with respect to the outside of the carcass reinforcement, this crown reinforcement comprising at least two superposed plies, each ply being provided with reinforcing members in the form of threads or cords, it is judicious to apply the teaching of patent EP 1 048 489. In this case, each flow deviation rib meets the requirements mentioned in that patent.

In this way, it is in fact possible both to achieve a substantial reduction in the power of the expelled water while still limiting the temperature rises near the ends of consecutive plies as a result of adding rubber material.

Preferably, the tires according to the invention are mounted on the front axle of the vehicles.

### BRIEF DESCRIPTION OF THE DRAWINGS

The invention will be more clearly understood from the figures appended to the present description and showing embodiments given by way of non-limiting examples:

FIG. 1 shows a schematic meridian section of part of a heavy-goods vehicle tire that includes an expelled-water deflecting rib on one of its sidewalls, this rib comprising a pressure-reducing device according to the invention;

FIG. 2 shows, in side view, the embodiment shown in FIG. 1;

FIG. 3 shows the embodiment of FIG. 1 in the configuration in which the tire is running on a roadway covered with water;

FIG. 4 shows another embodiment of the power-reducing device according to the invention, formed from a plurality of tabs;

FIG. 5 shows another embodiment of the power-reducing device according to the invention, formed from a zigzagged strip;

FIG. 6 shows another embodiment of the power-reducing device in a meridian section plane, in which the studs have an increasing variable cross section;

FIG. 7 shows another embodiment of the invention in a meridian section plane, in which the studs of the power-reducing device are oriented in a direction approximately parallel to the axial direction XX′; and

FIG. 8 shows the expulsions by the studs of the embodiment represented in FIG. 1 on a plane perpendicular to the rotation axis.

### DESCRIPTION OF THE PREFERRED EMBODIMENTS

To make it easier to examine the figures and read the corresponding description thereof, the same structural elements shown in these figures are denoted by the same reference signs.

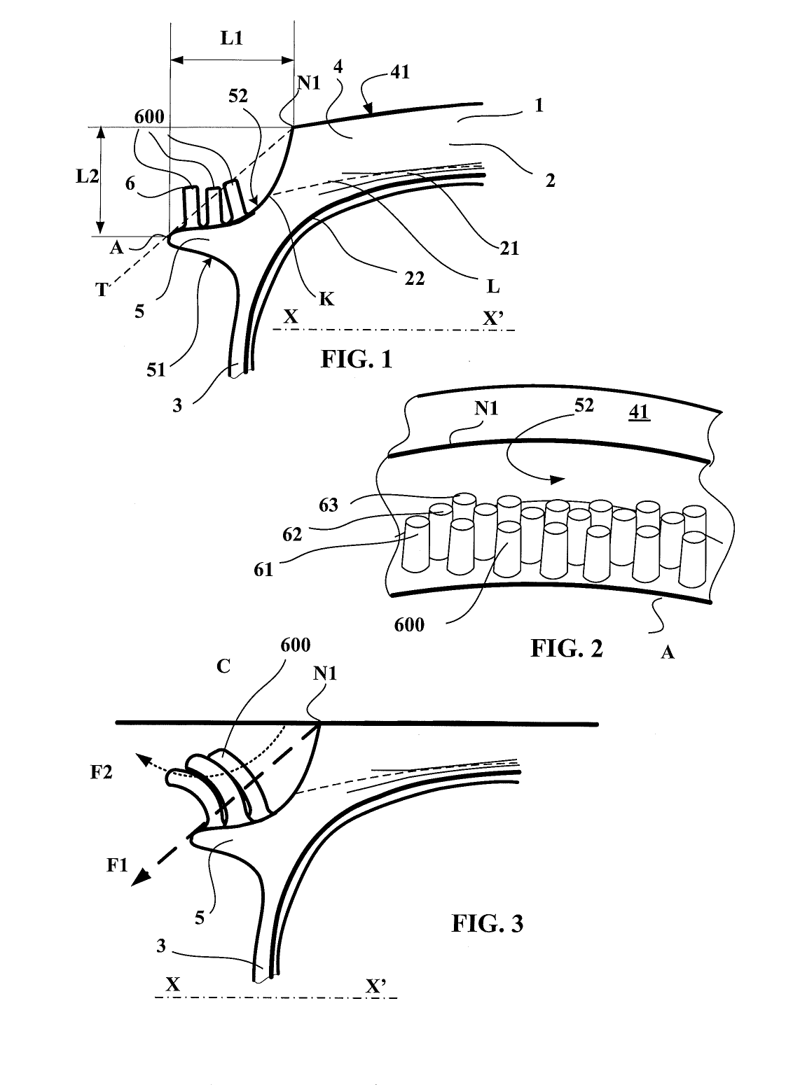

FIG. 1 shows a partial section of a heavy-goods vehicle tire 1 according to the invention produced in a meridian section plane, i.e. in a plane containing the rotation axis of said tire (this axis is parallel to the direction shown by the line XX′ in FIG. 1). This tire 1, of 385/55 R 22.5 size, comprises a crown region 2 connected to beads (not shown here) by sidewalls 3. The crown 2 of the tire includes a tread 4 having a radially external running surface 41, this running surface being intended to come into contact with the roadway while the tire is running thereon. This surface 41 terminates axially in a line, the intersection of which with the section plane corresponds to a point N1. Seen in the plane of section of the figure, the point N1 corresponds to the axially outermost point of the contact imprint of the running surface 41 under the nominal operating conditions of the tire.

Shown on the sidewall 3 is a rib 5 projecting towards the outside of the tire (by definition, the inside of the tire corresponds to the tire cavity in which the inflation pressure is exerted). The rib 5 in the present case is produced by molding at the same time as the tire 1 is molded and vulcanized.

The rib 5 comprises an external wall formed from a first wall part 51 and from a second wall part 52, the first part 51 extending between the sidewall 3 of the tire as far as a line joining the axially outermost points A of the rib, the second part 52 being in the extension of the first part 51 and extending radially outwards as far as the axially external edge N1 of the running surface 41.

Furthermore, the tire 1 is provided, on the rib 5, with a device 6 for reducing the power of the laterally expelled water when the tire is running on roadways covered with water. This device 6 is formed by three circumferential rows 61, 62, 63 of rubber studs 600. These studs 600 stand up on the second wall part 52 of the rib and are oriented approximately in a radial direction (i.e. in a direction perpendicular to the rotation axis of the tire). The axially outermost row 61 of studs 600 is positioned close to the axially outermost part of the rib (corresponding to the point A on the drawing). The studs 600 will have substantially the same height, have a circular cross section and have the following dimensions: diameter equal to 3.5 mm; height equal to 11 mm.

The height of the studs 600 is such that said studs intersect, in the plane of section, a virtual line T passing through the axially outermost point N1 of the running surface 41 of the tread, this line T being tangential to the rib 5 located axially to the outside of the point N1.

In the case presented, the axial distance L1 separating the axially outermost point N1 of the running surface 41 from the axially outermost point A of the rib 5 is equal to 30 mm, while the radial distance L2 between this point A and the point N1 is equal to 31 mm. The height of the studs 600 is equal to 11 mm. The diameter of each stud is approximately equal to 3.5 mm at one end and 5 mm at the other end (the largest diameter being located close to the external surface 52 of the rib 5). The average pitch between the studs is 9 mm.

As shown in FIG. 2, representing a partial side view of the rib of FIG. 1, the studs 600 are placed in circumferential rows 61, 62, 63 so that the studs of one row are circumferentially offset from the studs of the neighboring rows in order to increase the pressure drop effect. The void content here is of the order of 15%.

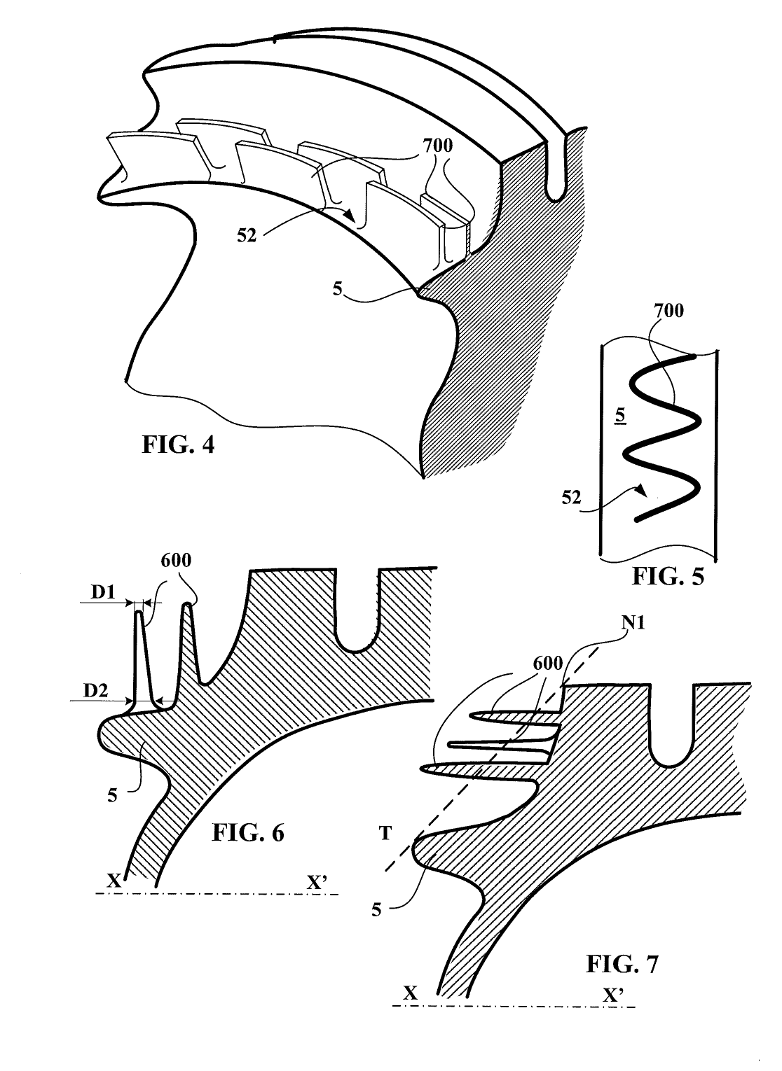

As is visible in FIG. 3, the presence of a rib 5 makes it possible for the water expelled laterally when the tire is running on a roadway C covered with water to be differently oriented (the orientation is indicated by the arrow F1) and the presence of the studs 600 makes it possible for the power of this water expulsion to be very perceptibly reduced, some of said expelled water being turned back to a greater or lesser extent towards the roadway (as indicated by the arrow F2).

Advantageously, the studs are joined to the rib via appropriate join radii which limit the stress concentrations due to repeated flexure, so as to prevent the studs from being torn off. Preferably, the join profile has a radius of curvature of at least 1 mm.

Of course, to benefit from the effects of the invention when the tire is running, the tire according to the invention is mounted on a vehicle in such a way that the sidewall provided with a rib and with an expelled-water power-reducing device is placed on the outside of said vehicle.

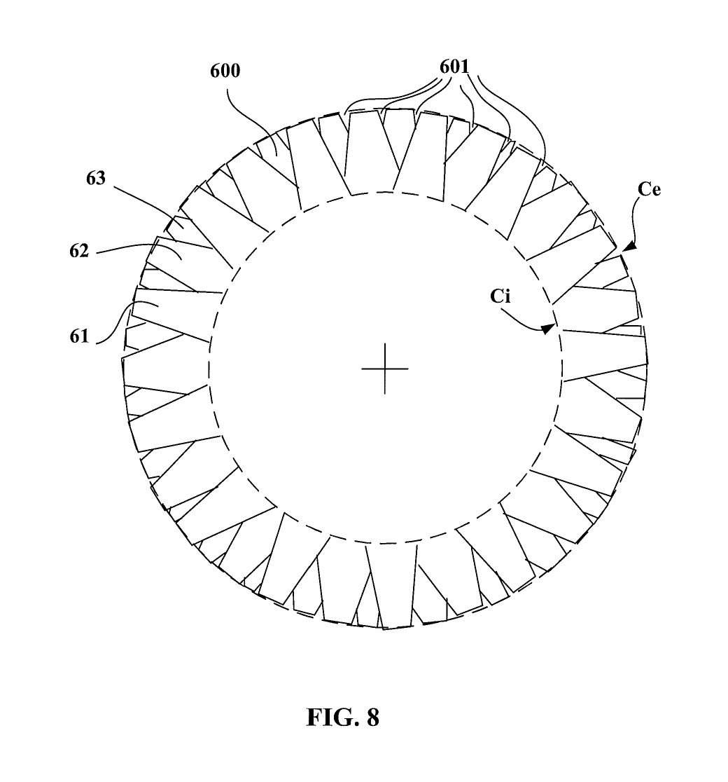

FIG. 8 shows the projections of the studs 61, 62, 63 of the power-reducing device 600 on a plane perpendicular to the rotation axis. In this embodiment, there are spaces 601 that are not plugged by at least one stud and that allow the liquid stream ejected while the tire is running to pass through in a direction perpendicular to the plane of the figure (i.e. parallel to the rotation axis). The ratio of the sum of these spaces 601 to the total area of the ring bounded by an internal circle Ci and an external circle Ce is less than 20%. In the embodiment shown, this ratio is equal to 16%. The internal circle Ci passes through the radially innermost part of the studs, whereas the external circle Ce passes through the radially outermost part of the studs.

Another embodiment is shown in FIG. 4, in which the rib 5 is provided with a power-reducing device made up of two circumferential rows of protuberances 700 projecting from the second part 52 of the external wall of the rib 5, each of these protuberances 700 being a rubber tab molded when the tire is being molded. Each tab has suitable dimensions for allowing appropriate flexure under the action of the expelled water when the tire is running on a roadway covered with water. Each row comprises a plurality of tabs placed approximately in the circumferential direction (their largest dimension is in the circumferential direction).

The embodiment in FIG. 5 shows, in side view, part of a rib 5 having, on its external surface 52, a power-reducing device formed from a continuous zigzagged strip 700 lying in the circumferential direction (the void content here is 0%). This continuous strip 700 could advantageously be incised in the radial direction, over all or part of its radial height, or else provided with a plurality of orifices for letting through only part of the stream.

In the embodiment shown in FIG. 6, a rib 5 is provided with studs 600, the cross-sectional area of which increases uniformly upon moving closer to the radially external wall of the rib 5. The cross section of each stud is circular and has a minimum diameter D1 at the free end of the stud, whereas it has a maximum diameter D2 close to the wall surface of the rib 5. In the case shown, the base of the studs has a region where it joins the rib so as to provide good anchoring of the stud and to avoid stress concentrations.

Advantageously, the second part of the external wall of the rib has a transverse curvature (measured in a section plane containing the rotation axis) such that, seen from the outside, this second part has a concavity turned towards the ground when the tire is running thereon. For the usual dimensions of heavy-goods vehicle tires, the average radius of this curvature (taken in a plane of section containing the rotation axis) is between 10 and 25 mm.

In another embodiment, shown in FIG. 7, the protuberances in the form of studs 600 may be placed close to the axially external edge of the running surface of the tread (intersecting the plane of the figure at the point N1), these protuberances being oriented in a direction approximately parallel to the axial direction XX′. These protuberances 600 have a length in the axial direction which is sufficient to intersect a virtual line T lying in the plane of the drawing, passing through the point N1 and tangential to the rib 5.

The invention is not limited to the examples described and shown, it being possible for various modifications to be made thereto without departing from the scope of the invention. All the embodiments described employ a continuous circumferential rib but of course it is possible to mould a discontinuous circumferential rib as a succession of rib portions, each rib portion being provided with a device for reducing the power of the water jet according to the invention.

1. Tyre having a tread, sidewalls extending the edges of the tread and, on at least one of its sidewalls, a rib for modifying the path of the expelled water in the case of the tyre running on wet ground, this rib being directed circumferentially and comprising an external wall formed from a first part and from a second part, the first part extending between a sidewall of the tyre as far as a line joining the axially outermost points of the rib, the second part being in the extension of the first part and extending radially outwards as far as an axially external edge of the tread, this tyre being characterized in that the rib includes a power-reducing device, said power-reducing device being positioned on the second part of the external wall of the rib and comprising at least one protuberance placed so as to create a pressure drop so as to reduce the power of the water expelled in the transverse direction in the case of the tyre running on water-covered ground, said at least one protuberance intersecting a virtual line tangential to both the axially outer edge of the tread and the rib on which said at least one protuberance is formed.

2. Tyre according to claim 1, wherein the at least one protuberance of the power-reducing device is formed by a plurality of studs of appropriate cross section and of appropriate length so as to generate a pressure drop in the expelled water.

3. Tyre according to claim 2, wherein the studs are placed in at least two circumferential lines on the second part of the external wall of the rib, the studs of one line being offset relative to the studs of a neighbouring line so as to create a large number of obstacles to the flow of water when the tyre is running on water-covered ground.

4. Tyre according to claim 1, wherein the void content of the protuberances of the power-reducing device, measured when projected on a plane perpendicular to the rotation axis, is at most equal to 15% of the total area of the studs projected on the same plane.

5. Tyre according to claim 1, wherein the studs have cross sections that increase in area upon coming closer to the wall of the circumferential rib.

6. Tyre according to claim 1, wherein the at least one protuberance of the power-reducing device is formed by at least one strip, the dimensions of the cross section of which, seen in a meridian section plane, are such that, under the action of the water stream, said strip deforms in bending, the at least one strip having a circumferential main orientation so as to reduce the power of the water expelled in the transverse direction in the case of the tyre running on water-covered ground.

7. Tyre according to claim 6, wherein the device for reducing the power of the jet is formed by a plurality of discontinuous circumferential tabs placed in circumferential rows, the tabs of one line being circumferentially offset relative to the tabs of another row and in that the void content of the tabs of the power-reducing device, measured when projected on a plane perpendicular to the rotation axis, is at most equal to 15% of the total area of the studs projected on the same plane.

8. Tyre according to claim 6, wherein the device for reducing the power of the jet is formed by at least one plurality of strips having a zigzag shape and oriented in the circumferential direction.
